(19) United States
(12) Patent Application Publication
(10) Pub. No.: US 2006/0066521 A1
(43) Pub. Date: Mar. 30, 2006

(54) Method for driving plasma display panel and plasma display device

(75) Inventors: Takashi Sasaki, Kawasaki (JP); Takayuki Kobayashi, Kawasaki (JP); Naoki Itokawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/235,235

(22) Filed: Sep. 27, 2005

(30) Foreign Application Priority Data
Sep. 27, 2004 (JP) 2004-280193

(51) Int. Cl. G09G 3/28

(52) U.S. Cl. 345/67

(57) ABSTRACT

A method for driving a plasma display panel and a plasma display device for improving the amount of emitted light are disclosed. In a three-electrode type PDP, a third (Z) electrode is provided between a first (X) electrode and a second (Y) electrode between which a discharge is caused to occur and at least during a discharge period during which a repetitive discharge (a sustain discharge) is caused to occur between the first and second electrodes, the third electrode is set to substantially the same potential as an electrode used as a cathode during the repetitive discharge between the first and second electrodes.

### BACKGROUND OF THE INVENTION

The present invention relates to an A/C-type plasma display panel (PDP) used as a display unit of a personal computer or a workstation, a flat TV, or as a plasma display for displaying advertisements, information, etc.

In an AC-type color PDP device, an address/display separation (ADS) system is widely adopted, in which a period for specifying cells to be used for display (address period), and a display period (sustain period) for causing a discharge to occur to light cells for display, are separated. In this system, charges are accumulated in the cells to be lit during the address period and a discharge is caused to occur for display during the sustain period by utilizing the charges.

Plasma display panels include: a two-electrode type PDP in which a plurality of first electrodes extending in a first direction are provided in parallel to each other and a plurality of second electrodes extending in a second direction perpendicular to the first direction are provided in parallel to each other; and a three-electrode type PDP in which a plurality of first electrodes and a plurality of second electrodes each extending in a first direction are alternately provided in parallel to each other and a plurality of address electrodes extending in a second direction perpendicular to the first direction are provided in parallel to each other. Recently, the three-electrode type PDP has been widely used.

In a general structure of the three-electrode type PDP, first (X) electrodes and second (Y) electrodes are alternately provided in parallel to each other on a first substrate, address electrodes extending in the direction perpendicular to the first and second electrodes are provided on a second substrate in opposition to the first substrate, and each surface of the electrodes is covered with a dielectric layer. On the second substrate, one-directional stripe-shaped ribs extending in parallel to the third electrode are further provided between the third electrodes, or two-dimensional grid-shaped ribs arranged in parallel to the address electrodes and the first and second electrodes are provided so that the cells are separated from one another and after phosphor layers are formed between the ribs, the first and second substrates are bonded together to each other. Therefore, there may be a case where the dielectric layers and the phosphor layers and, further, the ribs are formed on the third electrode.

After a discharge is caused to occur in all of the cells by applying a voltage between the first and second electrodes, the charges (wall charges) in the vicinity of the electrode are brought into a uniform state, and addressing is performed to selectively leave the wall charges in a cell to be lit by applying a scan pulse sequentially to the second electrode and applying an address pulse to the address electrode in synchronization with the scan pulse, a sustain discharge is caused to occur in the cell to be lit in order to light the cell in which the wall charges are formed by addressing by applying a sustain discharge pulse that alternately changes to the potential of opposite polarity between the neighboring first and second electrodes between which a discharge is caused to occur. The phosphor layer emits light, which is seen through the first substrate, by the ultraviolet rays generated by a discharge. Because of this, the first and second electrodes are composed of an opaque bus electrode made of metal material and a transparent electrode such as an ITO film, and light generated in the phosphor layer can be seen through the transparent electrode. As the structure and operation of a general PDP are widely known, a detailed explanation will not be given here.

Concerning the three-electrode type PDP as described above, various PDPs in which the third electrode is provided between the first electrode and the second electrode in parallel thereto have been proposed.

For example, Japanese Unexamined Patent Publication (Kokai) No. 6-260092 has described a PDP device of non-address/display separation (non-ADS) system using a PDP in which the third electrode is provided between the first electrode and the second electrode and in parallel thereto.

Japanese Unexamined Patent Publication (Kokai) No. 2000-123741 has described a PDP device that produces an interlaced display by using display lines between the first electrode and the third electrode and between the second electrode and the third electrode.

Japanese Unexamined Patent Publication (Kokai) No. 2002-110047 has described various PDPs in which the third electrode is provided between the first electrode and the second electrode in parallel thereto and a configuration in which the third electrode is used for various purposes.

Japanese Unexamined Patent Publication (Kokai) No. 2001-34228 and Japanese Unexamined Patent Publication (Kokai) No. 2004-192875 have described a configuration in which the third electrode is provided between the first electrode and the second electrode between which no discharge is caused to occur (non-display line) and the third electrode is used for a trigger operation, discharge prevention in a non-display line (reverse slit prevention), and a reset operation.

### SUMMARY OF THE INVENTION

A PDP device is required to have an improved luminance (amount of emitted light) and to be capable of providing a high display luminance. If the distance (slit width) between electrodes between which a discharge is caused to occur is increased and a long-distance discharge is caused to occur, light emission efficiency is improved, however, the discharge start voltage is raised and, therefore, it is necessary to raise a voltage to be applied, resulting in various problems such as that the cost of the drive circuit is increased. Japanese Unexamined Patent Publication (Kokai) No. 6-260092 and Japanese Unexamined Patent Publication (Kokai) No. 2002-110047 have described a configuration in which a long-distance discharge is caused to occur without increasing the discharge start voltage.

The object of the present invention is to realize a novel method for driving a plasma display and a plasma display panel, in which the amount of emitted light is increased by a principle completely different from the conventional one.

In order to attain the above-mentioned object, in a method for driving a plasma display panel (PD) according to the present invention, a third (Z) electrode is provided between a first (X) electrode and a second (Y) electrode between which a discharge is caused to occur in a three-electrode type PDP, and at least during the discharge period during which a discharge (sustain discharge) is caused to occur repeatedly between the first and second electrodes, the third electrode is set to substantially the same potential of the electrode used as a cathode for repetitive discharge between the first and second electrodes.

In other words, the method for driving a plasma display panel (PD) according to the present invention is characterized by being a method for driving a plasma display panel comprising a plurality of first electrodes and a plurality of second electrodes alternately provided in parallel to each other, between adjacent electrodes of which a discharge is caused to occur repeatedly, and a plurality of third electrodes provided between the first and second electrodes between which a discharge is caused to occur repeatedly and covered with a dielectric layer, wherein, at least during the discharge period during which a discharge is caused to occur repeatedly between the first and second electrodes, the third electrode is set to substantially the same potential of the electrode which is used as a cathode for the discharge between the first and second electrodes.

In a conventional PDP, the first and second electrodes were composed of first and second bus electrodes extending in parallel to each other and first and second transparent discharge electrodes provided so as to be connected to the first and second bus electrodes for each cell. In this configuration, a sustain discharge was caused to occur by repeatedly applying a sustain discharge pulse that alternately changes the polarity to the first and second electrodes. In other words, the first electrode is used alternately as an anode and as a cathode and, similarly, the second electrode is also used alternately as an anode and as a cathode. Therefore, in the conventional PDP, the shape of the first electrode was the same as that of the second electrode, the symmetry of discharge being taken into consideration.

The inventors of the present invention have conducted an experiment to study a relationship between the ratio of anode area to cathode area and the amount of emitted light when a discharge is caused to occur and have found that, when the cathode area is larger than the anode area, the amount of emitted light is large. Specifically, a case where the area ratio between the discharge region of cathode and that of anode was set to 3:1 was compared to a case where it was set to 1:3, and the result was that about 1.5 times the amount of visible light was output in the case where the cathode was larger than the anode compared to the other case. Therefore, in a discharge, it may be that the amount of emitted light due to the cathode is about double that due to the anode.

Therefore, in the present invention, in each sustain discharge caused to occur repeatedly, the third (Z) electrode is made to function as a cathode during the period from the start to the end of the discharge. Due to this, for example, when a discharge is caused to occur with the first (X) electrode as a cathode and the second (Y) electrode as an anode, a discharge is caused to occur with a wide region as a cathode, which is the sum of the first (X) electrode area and the third (Z) electrode area, generating a large amount of emitted light. Conversely, when a discharge is caused to occur with the first (X) electrode as an anode and the second (Y) electrode as a cathode, a discharge is caused to occur with a wide region as a cathode, which is the sum of the second (Y) electrode area and the third (Z) electrode area, generating a large amount of emitted light.

After the discharge comes to an end, negative wall charges are accumulated if the third (Z) electrode is made to function as an anode. Next, when a sustain discharge pulse, the polarity of which has been changed, is applied between the first (X) electrode and the second (Y) electrode, the third (Z) electrode is made to function again as a cathode. Hereinafter, by repeating the above-mentioned operation, a discharge generating a large amount of emitted light is caused to occur with the third (Z) electrode always as a cathode.

For example, if the area ratio between the first (X) discharge electrode, the second (Y) discharge electrode, and the third (Z) discharge electrode is set to 1:1:2, a discharge is always caused to occur with the area ratio 3:1 between the discharge region of the cathode and that of the anode, therefore, the amount of emitted light is increased and the display luminance is improved.

A discharge is caused to occur with a delay after a voltage is applied and, in a certain period of time, the discharge intensity reaches its peak and, then, the discharge intensity gradually falls and the discharge comes to an end. Ultraviolet rays are generated by the discharge and the ultraviolet rays excite the phosphors to generate visible light, which is then output to the outside of the panel through the glass substrate. The ultraviolet rays are absorbed by the glass substrate, not output to the outside and, therefore, they cannot be detected outside the panel. By the discharge, infrared rays are also generated along with the ultraviolet rays and the timing at which the ultraviolet rays are generated is almost the same as that at which the infrared rays are generated. Therefore, the change in the discharge state can be detected by measuring the infrared rays.

It is preferable that the timing at which the state in which the third (Z) electrode is made to function as a cathode is switched to another state in which the third (Z) electrode is made to function as an anode such that charges are accumulated be sufficiently after the discharge comes to an end. In other words, it is not preferable for the third (Z) electrode to be switched to an anode while the intensity of the output infrared rays is strong. Here, for example, it is recommended to switch the third (Z) electrode to an anode when the intensity of the output infrared rays falls to about 10% of the peak intensity.

A sustain discharge is caused to occur repeatedly, however, the number of floating charges in the discharge space is small at the beginning of the sustain discharge and it takes a long time before the discharge intensity reaches the peak value after the discharge is caused to occur by the application of a voltage. However, after the sustain discharge is caused to occur repeatedly several times, the time required for the discharge intensity to reach the peak value becomes shorter because the number of floating charges in the discharge space increases. Therefore, it is preferable for the period during which the third (Z) electrode is made to function as a cathode to be long at the beginning of the repeated discharge and to be shorter afterward.

The present invention can be applied to a method for driving a normal type plasma display panel (PD) in which a first electrode and a second electrode make a pair and a sustain discharge is caused to occur between the pair of first and second electrodes and also to a method for driving an ALIS system PDP described in Japanese Patent 2801893 in which a sustain discharge is caused to occur at every portion between the plurality of first and second electrodes. When the present invention is applied to a method for driving a normal type PDP, a common potential is applied to a plurality of third electrodes.

As an ALIS system PDP is driven in an interlaced manner, when the present invention is applied to a method for driving an ALIS system PDP, during the sustain discharge period in the odd-numbered field, the portion between the second (Y) electrode and the first (X) electrode adjacent to one side of the second (Y) electrode is a display line and a sustain discharge is caused to occur therebetween, therefore, the third (Z) electrode provided therebetween is set to a potential that makes the third (Z) electrode function as a cathode when a discharge is caused to occur repeatedly, and the portion between the second (Y) electrode and the first (X) electrode adjacent to the other side of the second (Y) electrode is a non-display line, therefore, the third (Z) electrode provided therebetween is set to a potential that prevents a discharge from occurring and propagating. Similarly, during the discharge period in the even-numbered field, the third (Z) electrode provided between the second electrode and the first (X) electrode adjacent to one side thereof is set to a potential that makes it function as a cathode when a discharge is caused to occur repeatedly, and the third (Z) electrode provided between the second (Y) electrode and the first (X) electrode adjacent to the other side thereof is set to a potential that prevents a discharge from occurring and propagating. Actually, in a neighboring display line, a sustain discharge pulse of an opposite phase is applied to the first (X) electrode and the second (Y) electrode and in a neighboring non-display line, a sustain discharge pulse of an opposite phase is applied to the first (X) electrode and the second (Y) electrode, therefore, it is necessary to divide the plurality of the third (Z) electrodes into four groups and to configure the groups so that respective different signals can be applied to the respective groups.

According to the present invention, it is possible to realize a method for driving a plasma display panel and a plasma display device capable of improving the amount of emitted light and of obtaining high display luminance.

### BRIEF DESCRIPTION OF THE DRAWINGS

The features and advantages of the invention will be more clearly understood from the following description taken in conjunction with the accompanying drawings in which:

FIG. 1 is a diagram showing a general configuration of a PDP device in a first embodiment of the present invention.

FIG. 2 is an exploded perspective view of a PDP in the first embodiment.

FIG. 3A and FIG. 3B are sectional views of the PDP in the first embodiment.

FIG. 4 is a diagram showing electrode shapes in the first embodiment.

FIG. 5 is a diagram showing drive waveforms in the first embodiment.

FIG. 6 is a diagram showing the detail of the drive waveforms during the sustain discharge period in the first embodiment.

FIG. 7 is a diagram showing a modification example of an electrode structure.

FIG. 8 is a diagram showing a modification example of drive waveforms during the sustain discharge period.

FIG. 9 is a diagram showing a general configuration of a PDP device in a second embodiment of the present invention.

FIG. 10 is a diagram showing electrode shapes in the second embodiment.

FIG. 11 is a diagram showing drive waveforms (odd-numbered field) in the second embodiment.

FIG. 12 is a diagram showing drive waveforms (even-numbered field) in the second embodiment.

FIG. 13 is a diagram showing a general configuration of a PDP device in a modification example of the second embodiment.

### DESCRIPTION OF THE PREFERRED EMBODIMENTS

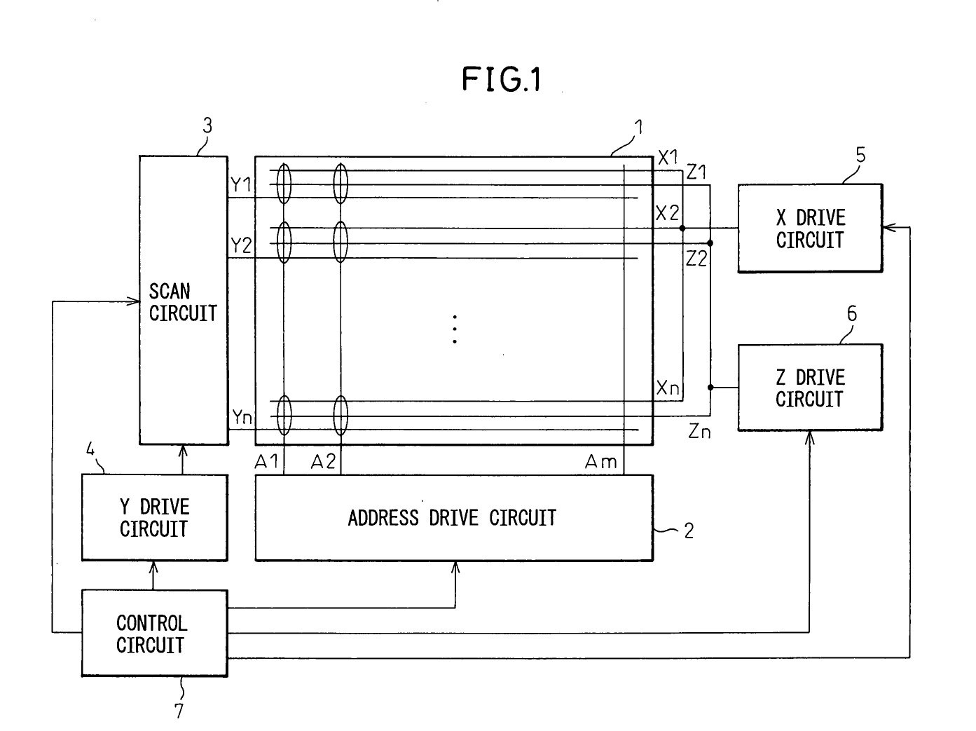

FIG. 1 is a diagram showing a general configuration of a plasma display device (PDP device) in a first embodiment of the present invention. A PDP 1 used in the PDP device in the first embodiment is a conventional PDP, in which a discharge is caused to occur between a pair of first (X) electrode and second (Y) electrode and to which the present invention is applied. As shown in FIG. 1, in the PDP 1 in the first embodiment, X electrodes X1, X2, . . . , Xn and Y electrodes Y1, Y2, . . . , Yn both extending in the transverse direction are alternately arranged and each of third electrodes Z1, Z2, . . . , Zn is arranged between each pair of X electrode and Y electrode. Therefore, n sets of the three electrodes, that is, the X electrode, the Y electrode, and the Z electrode, are formed. Further, address electrodes A1, A2, . . . , Am extending in the longitudinal direction are arranged so as to intersect the n sets of the X electrode, the Y electrode, and the Z electrode and a cell is formed at the intersection. Therefore, n display rows and m display columns are formed.

As shown in FIG. 1, the PDP device in the first embodiment comprises an address drive circuit 2 for driving the m address electrodes, a scan circuit 3 for applying a scan pulse to the n Y electrodes, a Y drive circuit 4 for commonly applying a voltage other than a scan pulse to the n Y electrodes via the scan circuit 3, an X drive circuit 5 for commonly applying a voltage to the n X electrodes, a Z drive circuit 6 for commonly applying a voltage to the n Z electrodes, and a control circuit 7 for controlling each component. The PDP device in the first embodiment differs from a conventional one in that the PDP 1 is provided with the Z electrodes and the Z drive circuit 6 for driving them, and other components are the same as those in the conventional one, therefore, only the components relating to the Z electrode are explained here and an explanation of other components will not be given here.

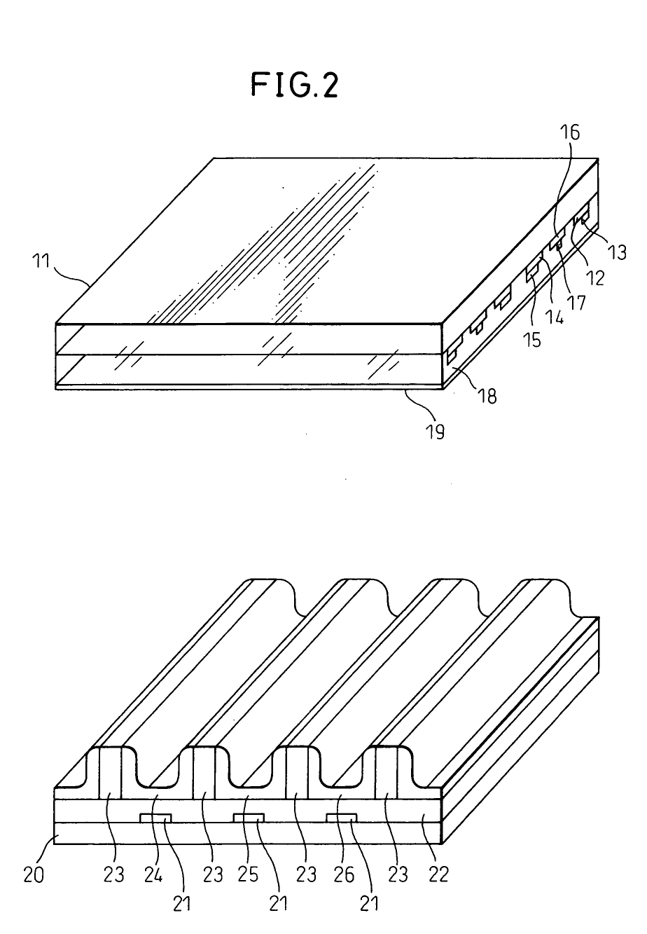

FIG. 2 is an exploded perspective view of the PDP in the first embodiment. As shown schematically, on a front (first) glass substrate 11, first (X) bus electrodes 13 and second (Y) bus electrodes 15 both extending in the transverse direction are alternately arranged in parallel to each other, making up pairs. X and Y light-transmitting electrodes (discharge electrodes) 12 and 14 are provided so as to overlap the X and Y bus electrodes 13 and 15 and parts of the X and Y discharge electrodes 12 and 14 are extending toward the electrodes in opposition thereto. Between a pair of X and Y bus electrodes 13 and 15, a third discharge electrode 16 and a third bus electrode 17 are provided so as to overlap each other. For example, the bus electrodes 13, 15, and 17 are formed by a metal layer and the discharge electrodes 12, 14, and 16 are formed by, for example, an ITO layer film, and the resistances of the bus electrodes 13, 15, and 17 are smaller than or equal to the resistances of the discharge electrodes 12, 14, and 16. Hereinafter, the parts of the X and Y discharge electrodes 12 and 14 extending from the X and Y bus electrodes 13 and 15 are simply referred to as X and Y discharge electrodes 12 and 14 and the third discharge electrode 16 and the third bus electrode 17 together are referred to as the third electrode.

On the discharge electrodes 12, 14, and 16 and the bus electrodes 13, 15, and 17, a dielectric layer 18 is formed so as to cover these electrodes. The dielectric layer 18 is composed of SiO₂ etc. that transmits visible light and is formed by a vapor-phase film-forming method and, further, a protective layer 19 such as MgO is formed thereon. The protective layer 19 causes a discharge to grow by emitting electrons by ion bombardment and has an effect of a reduction in discharge voltage, discharge delay, etc. In this structure, as all of the electrodes are covered with the protective layer 19, it becomes possible to cause a discharge to occur using the effect of the protective layer even if any electrode group is made to function as a cathode. The glass substrate 11 having the above-mentioned configuration is used as a front substrate and a display is seen through the glass substrate 11.

On the other hand, on a back (second) substrate 20, address electrodes 21 are provided so as to intersect the bus electrodes 13, 15, and 17. For example, the address electrode 21 is formed by a metal layer. On the address electrode group, a dielectric layer 22 is formed. Further, longitudinal direction ribs 23 are formed thereon. On the side face and the bottom face of a groove formed by the rib 23 and the dielectric layer 22, phosphor layers 24, 25, and 26 that generate red, green, and blue visible light by being excited by ultraviolet rays generated at the time of discharge.

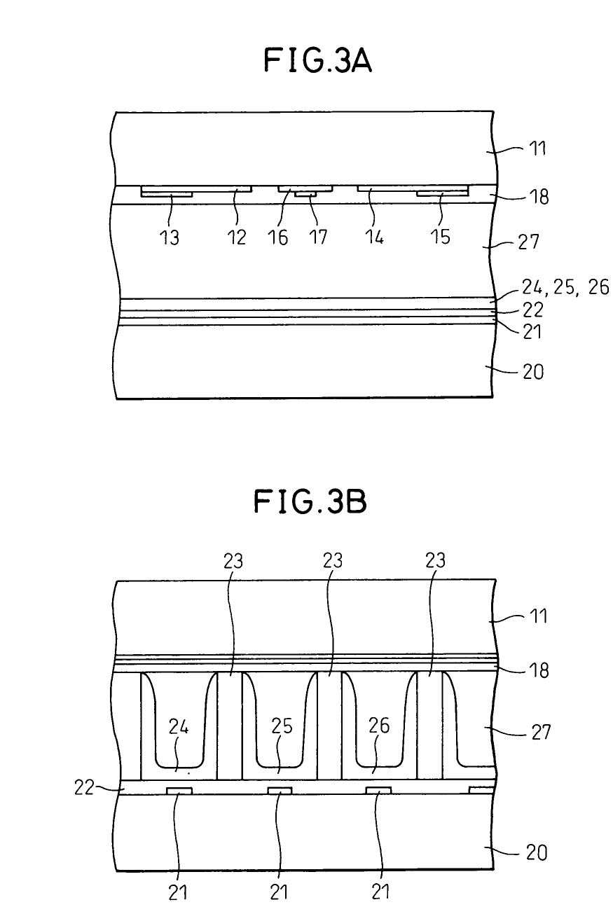

FIG. 3A and FIG. 3B are partial sectional views of PDP 1 in the first embodiment, wherein FIG. 3A is a longitudinal sectional view and FIG. 3B is a transverse sectional view. In a discharge space 27 between the front substrate 11 and the back substrate 20 defined by the ribs 23, a discharge gas such as Ne, Xe, He, etc., is sealed.

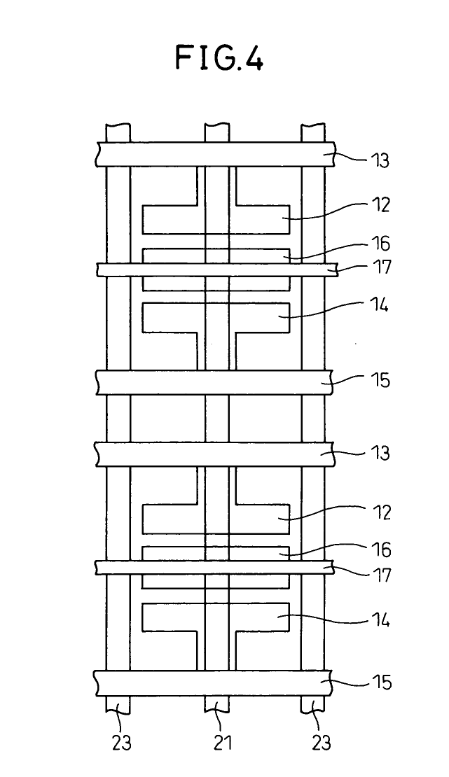

FIG. 4 is a diagram showing electrode shapes in two upper and lower cells. As shown schematically, the X bus electrode 13 and the Y bus electrode 15 are arranged in parallel to each other and the Z bus electrode 17 is arranged in parallel to each other at the center thereof. Then, the ribs 23 extending in the direction perpendicular to the bus electrodes 13, 15, and 17 are arranged. The address electrode 21 is arranged between the ribs 23. At each portion defined by the ribs 23, the T-shaped X discharge electrode 12 extending from the X bus electrode 13, the T-shaped Y discharge electrode 14 extending from the Y bus electrode 15, and the Z discharge electrode 16 extending in both the upward direction and the downward direction from the Z bus electrode 17 are provided. The edge of the X discharge electrode 12 and the edge of the Z discharge electrode in opposition to each other and the edge of the Y discharge electrode 14 and the edge of the Z discharge electrode in opposition to each other are parallel to the direction in which the bus electrodes 13, 15, and 17 extend and the distances therebetween are constant.

Next, the operation of the PDP device in the first embodiment is explained below. It is possible for each cell of the PDP to select only a lit state or an unlit state and it is not possible to change the luminance when lit, that is, to produce a graded display. Therefore, one frame is divided into a plurality of subfields with a predetermined weight and a graded display is produced by combining subfields to be lit in one frame for each cell. Normally, each subfield has the same drive sequence except for the number of sustain discharges.

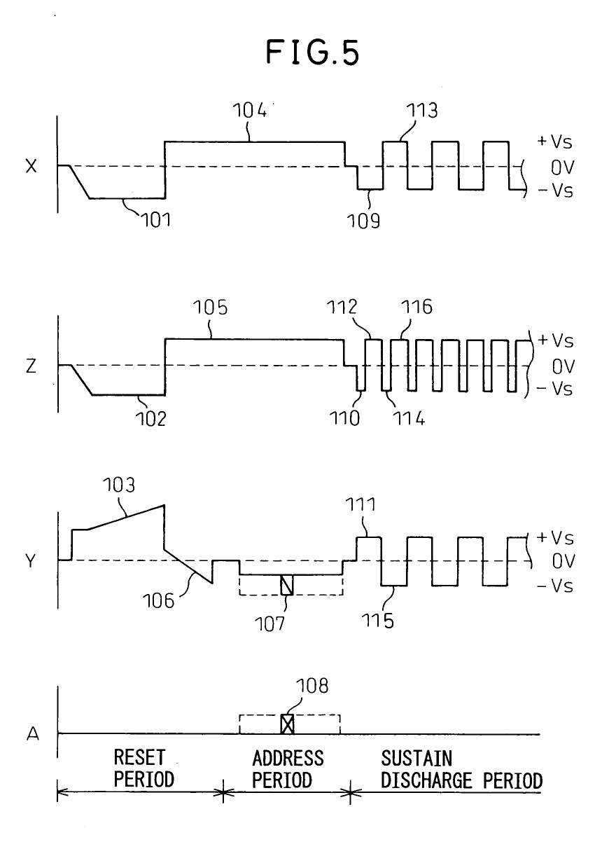

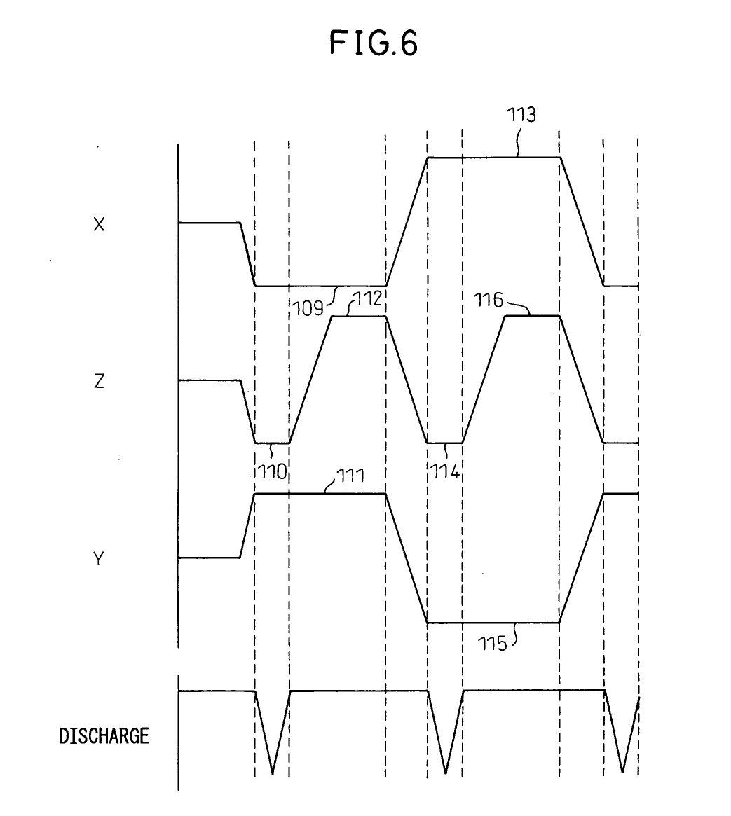

FIG. 5 is a diagram showing drive waveforms in a subfield of the PDP device of the first embodiment, and FIG. 6 is a diagram showing the detail of the drive waveforms during the sustain discharge period.

At the beginning of the reset period, in a state in which 0 V is applied to the address electrode A, negative reset pulses 101 and 102, the potentials of which gradually drop and then reach a constant potential, are applied to the X electrode and the Z electrode and, after a predetermined potential is applied, a positive reset pulse 103, the potential of which gradually increases, is applied to the Y electrode. Due to this, a discharge is first caused to occur between the Z discharge electrode 16 and the Y discharge electrode 14 in all of the cells and a transition takes place to a discharge between the X discharge electrode 12 and the Y discharge electrode 14. What is applied is an obtuse wave the potential of which changes gradually, therefore, a slight discharge is caused to occur and charges are formed repeatedly, and thus wall charges are formed uniformly in all of the cells. The polarity of the formed wall changes is positive in the vicinity of the X discharge electrode and the Z discharge electrode and negative in the vicinity of the Y discharge electrode.

Next, by applying positive compensation potentials 104 and 105 (for example, +Vs) to the X discharge electrode and the Z discharge electrode, and a compensation obtuse wave 106 the potential of which drops gradually, to the Y electrode the voltage having the polarity opposite to that of the formed wall charges described above is applied in the form of an obtuse wave, therefore, the number of wall charges in the cell is reduced by a slight discharge. As described above, when the reset period is completed, all of the cells are put into a uniform state.

In the PDP of the present embodiment, the distance between the Z discharge electrode 16 and the Y discharge electrode 14 is small and a discharge is caused to occur even at a low discharge start voltage and, with this discharge as a trigger, a transition takes place to a discharge between the X discharge electrode 12 and the Y discharge electrode 14, therefore, it is possible to reduce a reset voltage to be applied between the X electrode and the Y electrode and between the Z electrode and the Y electrode during the reset period. Due to this, it is possible to increase the contrast by reducing the amount of light emitted by a reset discharge that does not relate to a display.

During the next address period, the same voltage (for example, +Vs) as the compensation potentials 104 and 105 are applied to the X electrode and the Z electrode and, further, a scan pulse 107 is applied sequentially in a state in which a predetermined negative potential is applied to the Y electrode. In accordance with the application of the scan pulse 107, an address pulse 108 is applied to the address electrode of a cell to be lit. Due to this, a discharge is caused to occur between the Y electrode to which the scan pulse has been applied and the address electrode to which the address pulse has been applied and with this discharge as a trigger, a discharge is caused to occur between the X discharge electrode and the Y discharge electrode and between the Z discharge electrode and the Y discharge electrode. By this address discharge, negative wall charges are formed in the vicinity of the X electrode and the Z electrode (on the surface of the dielectric layer) and positive wall charges are formed in the vicinity of the Y electrode. Further, in the vicinity of the Y electrode, positive wall charges are formed and the number of which corresponds to the sum of the negative wall charges formed in the vicinity of the X electrode and the Y electrode. As no address discharge is caused to occur in a cell to which neither scan pulse nor address pulse is applied, therefore, the number of wall charges at the time of reset is maintained. During the address period, the above-mentioned operation is carried out by applying the scan pulse sequentially to all of the Y electrodes and an address discharge is caused to occur in all of the cells to be lit on the entire surface of the panel.

There may be a case where a pulse, for adjusting the wall charges formed during the reset period, is applied to a cell in which no address discharge has been caused to occur at the end of the address period.

During the sustain discharge period, first, a negative sustain discharge pulse 109 having a potential −Vs is applied to the X electrode, a negative pulse 110 having the potential −Vs is applied to the Z electrode, and a positive sustain discharge pulse 111 having the potential +Vs is applied to the Y electrode. In a cell in which an address discharge has been caused to occur, the voltage due to the positive wall charges formed in the vicinity of the Y electrode is added to the potential +Vs and the voltage due to the negative wall charges formed in the vicinity of the X electrode and the Z electrode is added to the potential −Vs. Due to this, the voltage between the X electrode and the Y electrode and between the Z electrode and the Y electrode exceeds the discharge start voltage and a discharge is caused to occur first across the small distance between the Z discharge electrode and the Y discharge electrode and, with this discharge as a trigger, a transition takes place to a discharge across the large distance between the X electrode and the Y electrode. The discharge between the X electrode and the Y electrode is a long-distance discharge and is a discharge with excellent light-emission efficiency.

As shown in FIG. 6, this discharge is caused to occur when −Vs is applied to the X and Z electrodes and +Vs is applied to the Y electrode (actually, the discharge is caused to occur with a delay somewhat after the application of the potential), and in a certain period of time, the discharge intensity reaches the peak value and then, the discharge intensity falls. In the first embodiment, when the discharge intensity falls sufficiently, a positive pulse 112 having the potential +Vs is applied to the Z electrode. The negative wall charges in the vicinity of the X electrode and the Z electrode and the positive wall discharge in the vicinity of the Y electrode have disappeared by the above-mentioned discharge and the positive charges generated by the discharge move to the vicinity of the X electrode and the Z electrode and the negative charges move to the vicinity of the Y electrode, however, a sufficient number of wall charges is not formed yet. Further, the voltage due to the charges in the vicinity of the Z electrode raises the potential of the Z electrode, however, the voltage due to the charges in the vicinity of the X electrode and the Y electrode raises the potential of the X electrode and the reduces the potential of the Y electrode, therefore, no discharge is caused to occur between the X electrode and the Z electrode and between the Y electrode and the Z electrode even if the pulse 112 is applied. When the potential +Vs is applied to the Z electrode, the positive charges in the vicinity of the Z electrode are not accumulated on the dielectric layer immediately above the Z electrode, but the negative charges move onto the dielectric layer immediately above the Z electrode and negative wall charges are formed. Positive wall charges are formed on the dielectric layer immediately above the X electrode and negative wall charges are formed on the dielectric layer immediately above the Y electrode.

The timing at which the pulse 112 having the potential +Vs is applied to the Z electrode is determined as follows. Ultraviolet rays are generated by a discharge, the ultraviolet rays excite phosphors to generate visible light, and it is output to the outside of the panel through the glass substrate. The ultraviolet rays are absorbed by the glass substrate, not output to the outside and therefore, the ultraviolet rays cannot be detected outside the panel. Along with the ultraviolet rays, infrared rays are also generated by a discharge and the timing at which the ultraviolet rays are generated is almost the same as that at which the infrared rays are generated. Therefore, it is possible to detect the change in state of a discharge by measuring the infrared rays. The intensity of the discharge in FIG. 6 is obtained by measuring infrared rays. Here, when the intensity of the infrared rays falls to 10% of the peak value, the application of the pulse 112 is started.

As described above, negative wall charges are formed in the vicinity of the Y electrode and the Z electrode and positive wall charge are formed in the vicinity of the X electrode. Next, if a pulse 113 having the potential +Vs is applied to the X electrode, a pulse 115 having the potential −Vs is applied to the Y electrode, and a pulse 114 having the potential −Vs is applied to the Z electrode, the voltage between the X electrode and the Y electrode and between the X electrode and the Z electrode exceeds the discharge start voltage because the voltage due to the wall charges is added thereto. Due to this, first, a discharge is caused to start across the small distance between the Z discharge electrode and the X discharge electrode and with this discharge as a trigger, a transition takes place to a discharge across the large distance between the X electrode and the Y electrode. This discharge uses the Z electrode as a cathode. Then, when the discharge intensity falls sufficiently, a positive pulse 116 having the potential +Vs is applied to the Z electrode. Due to this, negative wall charges are formed in the vicinity of the X electrode and the Z electrode and positive wall charges are formed in the vicinity of the Y electrode. Similarly, a sustain discharge is caused to occur repeatedly, with the Z electrode always a cathode, by applying a sustain discharge pulse that changes its polarity alternately to the X electrode and the Y electrode and applying a pulse the frequency of which is double that of the sustain discharge pulse to the Z electrode.

Although the first embodiment of the present invention is described as above, there may be various modification examples of the electrode structure and shape. Some of modification examples are explained below.

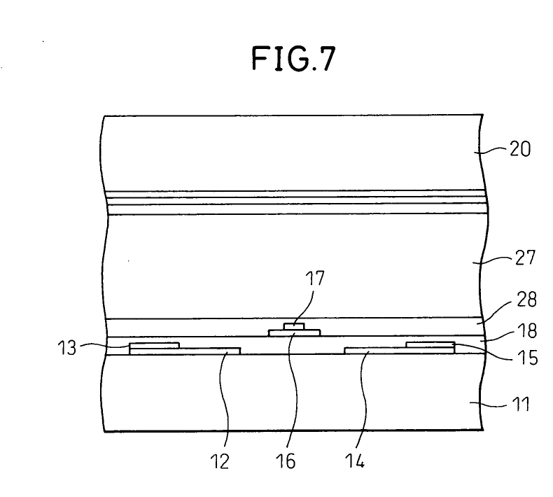

FIG. 7 is a diagram showing a modification example of an electrode structure. In the first embodiment, as shown in FIG. 3 (A), the Z electrodes (the Z discharge electrode 16, the Z bus electrode 17) are formed in the same layer in which the X electrodes (the X discharge electrode 12, the X bus electrode 13) and the Y electrodes (the Y discharge electrode 14, the Y bus electrode 15) are formed. In this configuration, it is possible to form the Z electrode in the same process as that for the X the electrode and the Y electrode and it is not necessary to employ a new process for providing the Z electrode. However, there arises a problem that, as the Z electrode is provided between the X discharge electrode 12 and the Y discharge electrode 14, the Z electrode short circuits to the X discharge electrode 12 and the Y discharge electrode 14 owing to the variations in position and line width in the manufacturing process, and the yield is reduced. Therefore, in the modification example in FIG. 7, the Z electrodes (the Z discharge electrode 16, the Z bus electrode 17) are formed on the dielectric layer 18 covering the X electrodes (the X discharge electrode 12, the X bus electrode 13) and the Y electrodes (the Y discharge electrode 14, the Y bus electrode 15) and further, a dielectric layer 28 is formed thereon so as to cover them. In this configuration also, the same operation as that in the first embodiment is possible.

The modification example in FIG. 7 has a problem that the manufacturing cost is increased because the process for providing the Z electrode is added compared to the first embodiment, however, as the Z electrode is formed in a layer different from that in which the X electrode and the Y electrode are formed, the Z electrode does not short circuit to the X discharge electrode 12 and the Y discharge electrode 14 and the yield is not reduced because there is no short circuit. Further, as the Z electrode is provided in a different layer, it is also possible to make very narrow the distances between the Z electrode and the X discharge electrode 12 and between the Z electrode and the Y discharge electrode 14 when seen in the direction perpendicular to the substrate, and a distance that approximately satisfies the Paschen minimum can also be obtained.

Further, as shown in FIG. 4, the X discharge electrode 12 and the Y discharge electrode 14 are T-shaped and are independent of the discharge electrodes in a cell in the vicinity thereof, however, it is also possible to provide the X and Y discharge electrodes in parallel to the X and Y bus electrodes and use the conventional electrode shapes in which electrodes for connecting the X and Y bus electrodes and the X and Y discharge electrodes are formed at the portion of the ribs.

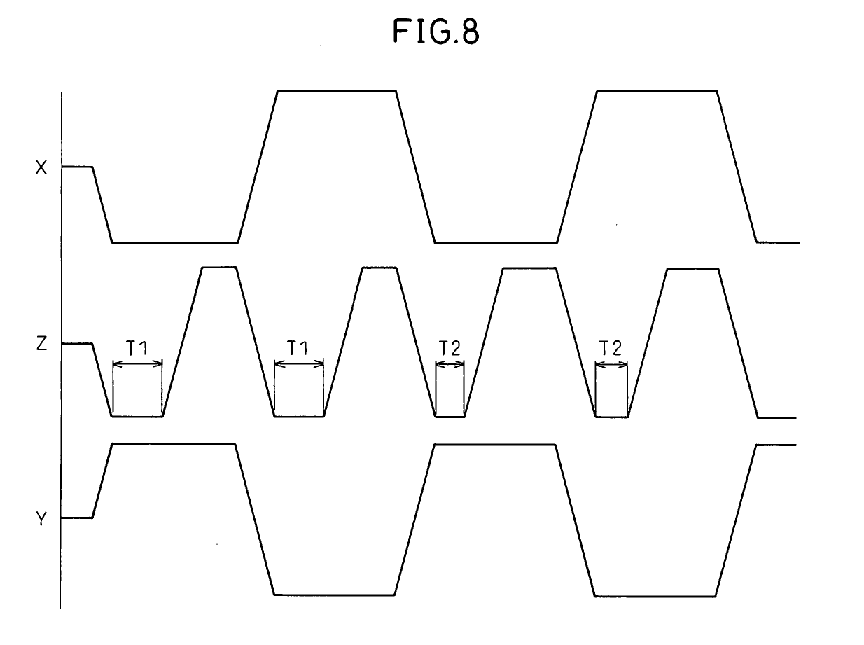

FIG. 8 is a diagram showing a modified example, of the drive waveforms, corresponding to FIG. 6. As is obvious from a comparison with FIG. 6, the drive waveforms in this example differ from those in FIG. 6 in that the width of the negative pulse having the potential −Vs to be applied to the Z electrode repeatedly is T1 for the first two pulses and those after the third pulse have a width T2 narrower than T1. The first sustain discharge is caused to occur using the wall charges formed by an address discharge, however, the number of wall charges formed by the address discharge is small and the number of floating charges in the discharge space is also small, therefore, even if the first sustain discharge pulse (including the pulse to the Z electrode) is applied, the occurrence of a discharge is delayed and the completion of the discharge is delayed accordingly. In contrast to this, when a sustain discharge is caused to occur repeatedly, wall charges, the number of which is larger than that of wall charges formed by an address discharge, are formed and the number of floating charges in the discharge space also increases, therefore, the delay between the application of a sustain discharge pulse and the occurrence of a discharge, and the delay between the application of a sustain discharge and the completion of the discharge, are reduced. Therefore, in the present example, at the beginning of a sustain discharge (two discharges), the period of time during which the negative potential −Vs is being applied to the Z electrode is lengthened and afterward, the period of time is shortened. In other words, the period of time during which the Z electrode is used as a cathode is lengthened at the beginning of the repetitive discharge and afterward, it is shortened. Due to this, a sufficient amount of wall charges can be formed in the vicinity of the Z electrode and a stable sustain discharge can be made to occur.

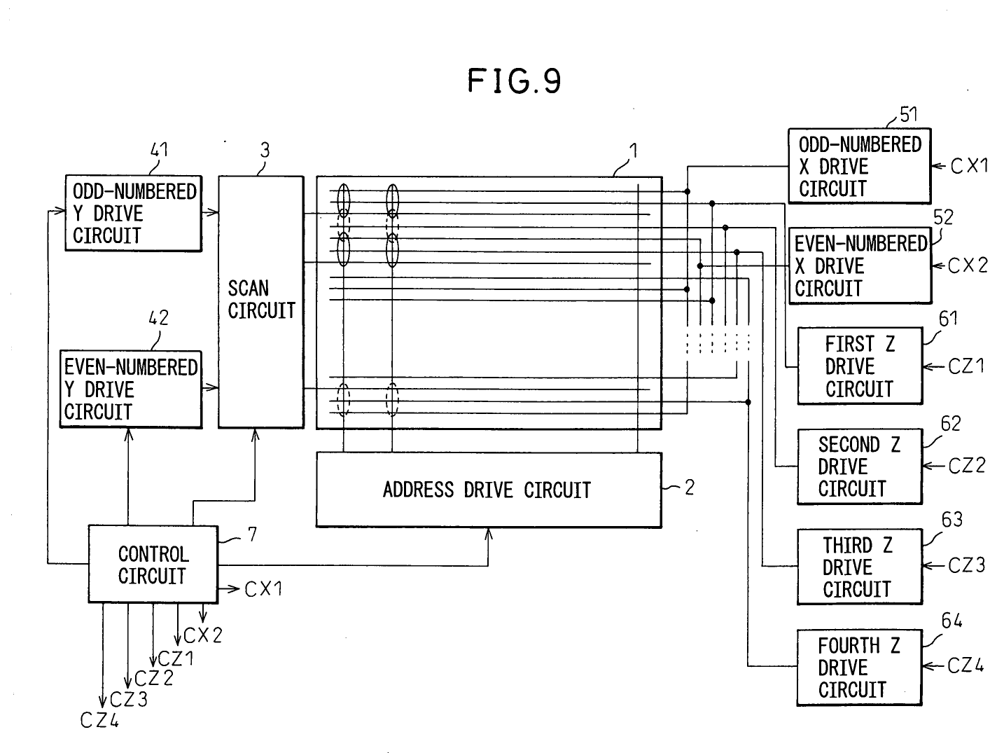

FIG. 9 is a diagram showing a general configuration of a PDP device in a second embodiment of the present invention. The second embodiment is an example in which the present invention is applied to an ALIS system PDP device described in Japanese Patent No. 2801983 and, in the configuration in which first and second electrodes (X and Y electrodes) are provided on a first substrate (a transparent substrate) and address electrodes are provided on a second substrate (a back substrate), a third electrode (a Z electrode) is provided between the X electrode and the Y electrode. As the ALIS system is described in Japanese Patent No. 2801893, a detailed explanation will not be given here.

As shown in FIG. 9, the plasma display panel 1 has a plurality of first electrodes (X electrodes) and second electrodes (Y electrodes) extending in the transverse direction (lengthwise direction). The plurality of X electrodes and Y electrodes are alternately arranged and the number of X electrodes is greater than that of Y electrodes by one. Between the X electrode and the Y electrode, a third electrode (a Z electrode) is arranged. Therefore, the number of Z electrodes is double that of Y electrodes. The address electrode extends in the direction perpendicular to the X, Y, and Z electrodes. In an ALIS system, all of the portions between the X electrode and the Y electrode are used as display lines and odd-numbered display lines and even-numbered display lines are used to produce an interlaced display. In other words, odd-numbered display lines are formed between an odd-numbered X electrode and an odd-numbered Y electrode and between an even-numbered X electrode and an even-numbered Y electrode, and even-numbered display lines are formed between an odd-numbered Y electrode and an even-numbered X electrode and between an even-numbered Y electrode and an odd-numbered Y electrode. One display field is composed of an odd-numbered field and an even-numbered field and, in the odd-numbered field, odd-numbered display lines are displayed and in the even-numbered field, even-numbered display lines are displayed. Therefore, the respective Z electrodes exist between respective odd-numbered display lines and respective even-numbered display lines. Here, the Z electrodes provided between an odd-numbered X electrode and an odd-numbered Y electrode are referred to as the Z electrodes in a first group, the Z electrodes provided between an odd-numbered Y electrode and an even-numbered X electrode are referred to as the Z electrodes in a second group, the Z electrodes provided between an even-numbered X electrode and an even-numbered Y electrode are referred to as the Z electrodes in a third group, and the Z electrodes provided between an even-numbered Y electrode and an odd-numbered X electrode are referred to as the Z electrodes in a fourth group, respectively. In other words, the (4p+1)-th (p is a natural number) Z electrode is a Z electrode in the first group, the (4p+2)-th Z electrode is a Z electrode in the second group, the (4p+3)-th Z electrode is a Z electrode in the third group, and the (4p+4)-th electrode is a Z electrode in the fourth group.

As shown in FIG. 9, the PDP device in the second embodiment comprises the address drive circuit 2 for driving the address electrode, the scan circuit 3 for applying a scan pulse to the Y electrode, an odd-numbered Y drive circuit 41 for commonly applying a voltage other than the scan pulse to an odd-numbered Y electrode via the scan circuit 3, an even-numbered Y drive circuit 42 for commonly applying a voltage other than the scan pulse to an even-numbered Y electrode via the scan circuit 3, an odd-numbered X drive circuit 51 for commonly applying a voltage to an odd-numbered X electrode, an even-numbered X drive circuit 52 for commonly applying a voltage to an even-numbered X electrode, a first Z drive circuit 61 for commonly driving the Z electrodes in the first group, a second Z drive circuit 62 for commonly driving the Z electrodes in the second group, a third Z drive circuit 63 for commonly driving the Z electrodes in the third group, a fourth Z drive circuit 64 for commonly driving the Z electrodes in the fourth group, and the control circuit 7 for controlling each component.

The PDP in the second embodiment has the same structure as that in the first embodiment except in that the X discharge electrode and the Y discharge electrode are provided on both sides of the X bus electrode and the Y bus electrode, respectively, and that the Z electrode is provided at every portion between the X bus electrode and the Y bus electrode and, therefore, an exploded perspective view is omitted here. It is also possible to form the Z electrode in the same layer in which the X and Y electrodes are formed as shown in FIG. 3 or to form in a layer different from that in which the X and Y electrodes are formed as shown in FIG. 7.

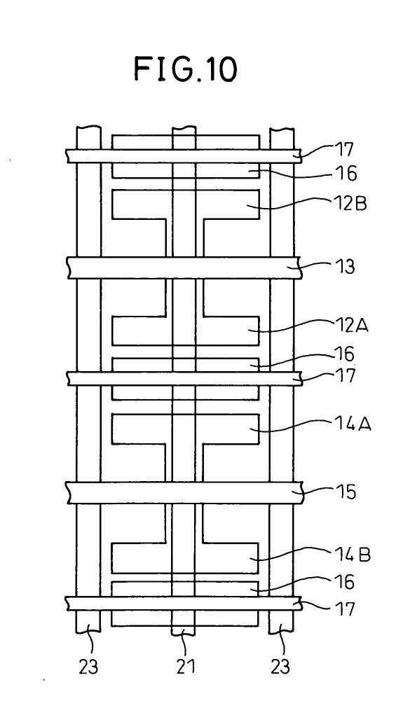

FIG. 10 is a diagram showing electrode shapes in the second embodiment. As shown schematically, the X bus electrode 13 and the Y bus electrode 15 are arranged at an equal interval in parallel to each other and the Z electrodes 16 and 17 are arranged at the center thereof in parallel to each other. Then, the ribs 23 extending in the direction perpendicular to the bus electrodes 13, 15, and 17 are arranged. Between the ribs 23, the address electrode 21 is arranged. At each portion defined by the ribs 23, an X discharge electrode 12A extending downward from the X bus electrode 13, an X discharge electrode 12B extending upward from the X bus electrode 13, a Y discharge electrode 14A extending upward from the Y bus electrode 15, a Y discharge electrode 14B extending downward from the Y bus electrode 15, and the Z discharge electrode 16 extending both upward and downward from the Z bus electrode 17 are provided. The edges of the X discharge electrodes 12A and 12B, the edges of the Y discharge electrodes 14A and 14B, and the edges of the Z discharge electrode 16 in opposition to each other are parallel to the direction in which the X bus electrode 13, the Y bus electrode 15, and the Z electrode 17 extend.

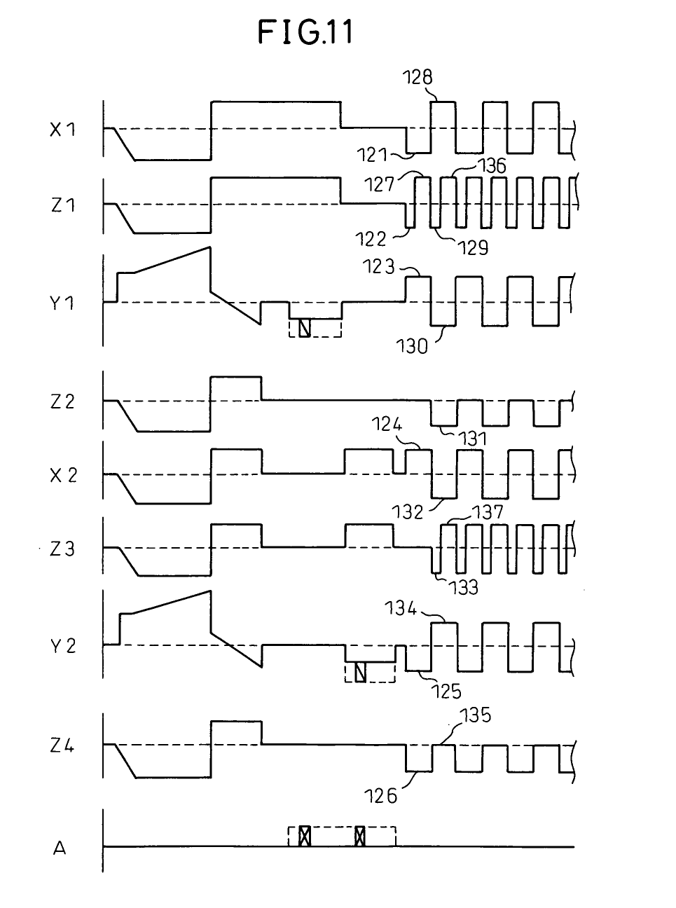

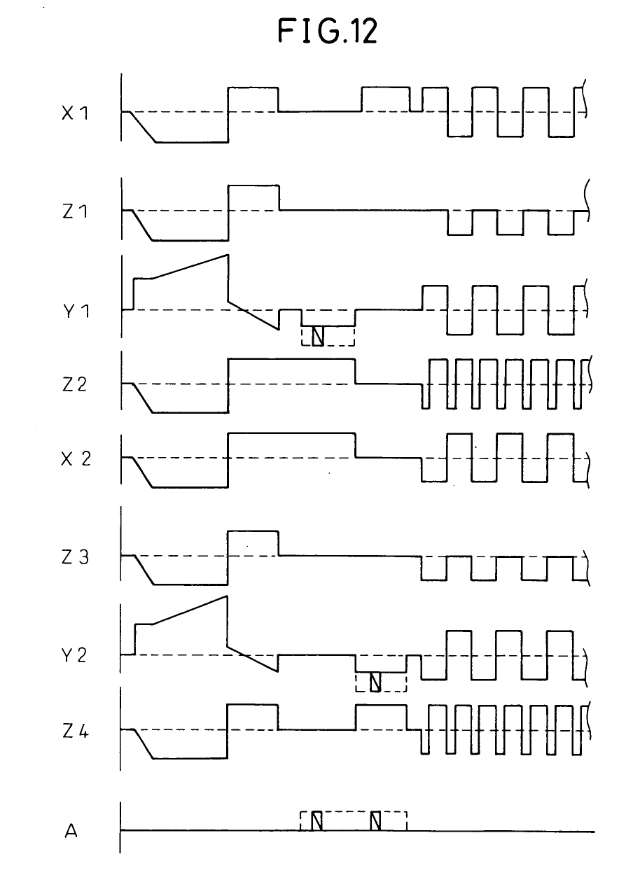

FIG. 11 and FIG. 12 are diagrams showing drive waveforms of the PDP device in the second embodiment, wherein FIG. 11 shows drive waveforms in the odd-numbered field and FIG. 12 shows drive waveforms in the even-numbered field. The drive waveforms to be applied to the X electrode, the Y electrode, and the address electrode are the same as the drive waveforms described in Japanese Patent No. 2801893 etc., and to the Z electrode provided between the X electrode and the Y electrode between which a discharge is caused to occur, the same drive waveforms as those shown in FIG. 5 and FIG. 6 are applied, and drive waveforms that prevent the occurrence of a discharge and propagation of a discharge are applied to the Z electrode provided between the X electrode and the Y electrode between which no discharge is caused to occur.

The drive waveforms during the reset period are the same as the drive waveforms in the first embodiment and all the cells are put into a uniform state during the reset period.

During the first half of the address period, a predetermined potential (for example, +Vs) is applied to an odd-numbered X electrode X1 and a Z electrode Z1 in the first group, an even-numbered X electrode X2, an even-numbered Y electrode Y2, and Z electrodes Z2 to Z4 in the second to fourth groups are set to 0 V and, in a state in which a predetermined negative potential is applied to an odd-numbered Y electrode Y1, a scan pulse is further applied sequentially. In accordance with the application of a scan pulse, an address pulse is applied to the address electrode in a cell to be lit. Due to this, a discharge is caused to occur between the odd-numbered Y electrode Y1 to which the scan pulse has been applied and the address electrode to which the address pulse has been applied, and with this as a trigger, a discharge is caused to occur between the odd-numbered X electrode X1 and the odd-numbered Y electrode Y1 and between the Z electrode Z1 in the first group and the odd-numbered Y electrode Y1. Due to this address discharge, negative wall charges are formed in the vicinity of the odd-numbered X electrode X1 and the Z electrode Z1 in the first group (at the surface of the dielectric layer) and positive wall charges are formed in the vicinity of the odd-numbered Y electrode Y1. As no address discharge is caused to occur in a cell to which neither a scan pulse nor an address pulse is applied, the wall charges at the time of reset are maintained. During the first half of the address period, the above-mentioned operation is carried out by sequentially applying the scan pulse to all of the odd-numbered Y electrodes Y1.

During the second half of the address period, a predetermined potential is applied to the even-numbered X electrode X2 and the Z electrode Z3 in the third group, the odd-numbered X electrode X1, the odd-numbered Y electrode Y1, and Z electrodes Z1, Z2, and Z4 in the first, second, and fourth groups are set to 0 V and, in a state in which a predetermined negative potential is applied to the even-numbered Y electrode Y2, a scan pulse is further applied sequentially. In accordance with the application of the scan pulse, an address pulse is applied to the address electrode in a cell to be lit. Due to this, a discharge is caused to occur between the even-numbered Y electrode Y2 to which the scan pulse has been applied and the address electrode to which the address pulse has been applied and, with this as a trigger, a discharge is caused to occur between the even-numbered X electrode X2 and the even-numbered Y electrode Y2 and between the Z electrode Z3 in the third group and the even-numbered Y electrode Y2. Due to this address discharge, negative wall charges are formed in the vicinity of the even-numbered X electrode X2 and the Z electrode Z3 in the third group and positive wall charges are formed in the vicinity of the even-numbered Y electrode Y2. During the second half of the address period, the above-mentioned operation is carried out by sequentially applying the scan pulse to all of the even-numbered Y electrodes Y2.

In the above-mentioned manner, addressing of the display lines between the odd-numbered X electrode X1 and the odd-numbered Y electrode Y1 and between the even-numbered X electrode X2 and the even-numbered Y electrode Y2, that is, addressing of the odd-numbered display lines is completed. In a cell in which the address discharge has been caused to occur, positive wall charges are formed in the vicinity of the odd-numbered Y electrode Y1 and the even-numbered Y electrode Y2 and negative wall charges are formed in the vicinity of the odd-numbered X electrode X1, the even-numbered X electrode X2, and the Z electrodes Z1 and Z3 in the first and third groups.

During the sustain discharge period, first, negative sustain discharge pulses 121 and 125 having the potential −Vs are applied to the odd-numbered X electrode X1 and the even-numbered Y electrode Y2, positive sustain discharge pulses 123 and 124 having the potential +Vs are applied to the odd-numbered Y electrode Y1 and the even-numbered X electrode X2, a negative pulse 122 having the potential −Vs is applied to the Z electrode Z1 in the first group, a negative pulse 126 having the potential −Vs is applied to the Z electrode Z4 in the fourth group, and 0 V is applied to the Z electrode Z2 in the second group and the Z electrode Z3 in the third group. At the odd-numbered X electrode X1 and the Z electrode Z1 in the first group, the voltage due to the negative wall charges is added to the potential −Vs, and at the odd-numbered Y electrode Y1, the voltage due to the positive wall discharges is added to the potential +Vs, and a large voltage is applied between them. Due to this, a discharge is first caused to start across the small distance between the Z electrode Z1 in the first group and the odd-numbered Y electrode Y1 and, with this as a trigger, a transition takes place to a discharge across the large distance between the odd-numbered X electrode X1 and the odd-numbered Y electrode Y1. When this discharge comes to an end, a positive pulse 127 having the potential +Vs is applied to the Z electrode Z1 in the first group as in the first embodiment. Due to this, positive wall charges are formed in the vicinity of the odd-numbered X electrode X1 and the Z electrode Z1 in the first group and negative wall charges are formed in the vicinity of the odd-numbered Y electrode Y1.

At this time, at the even-numbered X electrode X2 and the Z electrode Z3 in the third group, the voltage due to the negative wall charges is added to the potential +Vs and at the even-numbered Y electrode Y2, the voltage due to the positive wall charges is added to the potential −Vs, therefore, the voltage between electrodes is reduced and no discharge is caused to occur and, therefore, the wall charges are maintained.

Further +Vs is applied to the odd-numbered Y electrode Y1 and the even-numbered X electrode X2 and −Vs is applied to the even-numbered Y electrode Y2 and the odd-numbered X electrode X1, therefore, no discharge is caused to occur. The potential Vs is applied to the odd-numbered Y electrode Y1, 0 V is applied to the Z electrode Z2 in the second group, the voltage due to the positive wall charges is added at the odd-numbered Y electrode Y1 and, thus the voltage between the odd-numbered Y electrode Y1 and the Z electrode Z2 in the second group becomes high, however, the voltage applied to the Z electrode Z2 in the second group is 0 V, and no wall charges are formed at the Z electrode Z2 in the second group, therefore, the voltage due to the wall charges is not added and, therefore, no discharge is caused to occur. Conversely, it is necessary to set the voltage to be applied to the Z electrode Z2 in the second group to a voltage that does not cause a discharge to occur. However, it is preferable for the voltage to be applied to the Z electrode Z2 in the second group to be lower than the voltage +Vs to be applied to the neighboring odd-numbered Y electrode Y1 and the even-numbered X electrode X2. This is because, if a sustain discharge is caused to occur between the odd-numbered X electrode X1 and the odd-numbered Y electrode Y1, electrons are apt to start to move from the odd-numbered X electrode X1 toward the odd-numbered Y electrode Y1 and if the voltage of the Z electrode Z2 in the second group is the same as the voltage of the odd-numbered Y electrode Y1, the electrons continue to move toward the Z electrode Z2 in the second group as it is, and can move as far as the even-numbered X electrode X2. If this happens, the next application of the sustain discharge pulse having the opposite polarity causes an erroneous discharge to occur, resulting in a display error. In contrast to this, as in the present embodiment, if the voltage of the Z electrode Z2 in the second group is reduced lower than the voltage of the odd-numbered Y electrode Y1, the movement of electrons can be prevented and an erroneous discharge can be prevented from occurring between neighboring display lines.

Next, positive sustain discharge pulses 128 and 134 having the potential +Vs are applied to the odd-numbered X electrode X1 and the even-numbered Y electrode Y2, negative sustain discharge pulses 130 and 132 having the potential −Vs are applied to the odd-numbered Y electrode Y1 and the even-numbered X electrode X2, negative pulses 129 and 133 having the potential −Vs are applied to the Z electrode Z1 in the first group and the Z electrode Z3 in the third group, a negative pulse 131 having the potential −Vs is applied to the Z electrode Z2 in the second group, and a pulse 135 at 0 V is applied to the Z electrode Z4 in the fourth group. At the odd-numbered X electrode X1 and the Z electrode Z1 in the first group, positive wall charges are formed by the previous sustain discharge as described above and the voltage due to these charges is added to the potential +Vs, and at the odd-numbered Y electrode Y1, the voltage due to the negative wall charges formed by the previous sustain discharge is added to the potential −Vs, and a large voltage is applied between them. Further, at the even-numbered X electrode X2 and the Z electrode Z3 in the third group, the negative wall charges at the end of addressing are maintained and the voltage due to these charges is added to the potential −Vs and at the even-numbered Y electrode Y2, the positive wall charges at the end of addressing are maintained and the voltage due to these charges is added to the potential +Vs, and a large voltage is applied between them. Due to this, a discharge is caused to start across the small distance between the Z electrode Z1 in the first group and the odd-numbered Y electrode Y1 and across the small distance between the Z electrode Z3 in the third group and the even-numbered Y electrode Y2, and with this as a trigger, a transition takes place to a discharge across the large distance between the odd-numbered X electrode X1 and the odd-numbered Y electrode Y1 and across the large distance between the even-numbered X electrode X2 and the even-numbered Y electrode Y2. When this discharge comes to an end, as in the first embodiment, positive pulses 136 and 137 having the potential +Vs are applied to the first Z electrode Z1 in the first group and the Z electrode Z3 in the third group. Due to this, positive wall charges are formed in the vicinity of the odd-numbered X electrode X1 and the Z electrode Z1 in the first group and in the vicinity of the even-numbered X electrode X2 and the Z electrode Z3 in the third group, and negative wall charges are formed in the vicinity of the odd-numbered Y electrode Y1 and the even-numbered Y electrodes Y1 and Y2.

At this time, the same voltage −Vs is applied between the odd-numbered Y electrode Y1 and the even-numbered X electrode X2 and between the odd-numbered Y electrode Y1 and the Z electrode Z1 in the second group and the same voltage +Vs is applied between the even-numbered Y electrode Y2 and the odd-numbered X electrode X1, therefore, no discharge is caused to occur. Further, the voltage Vs is applied between the even-numbered Y electrode Y2 and the Z electrode Z4 in the fourth group, however, no discharge is caused to occur, as described above, and the electrons generated in the neighboring cells are prevented from moving and an erroneous discharge is prevented from occurring.

After this, by applying the sustain discharge pulse while inverting the polarities and by applying a pulse to each Z electrode, the sustain discharge is caused to occur repeatedly.

As described above, the first sustain discharge is caused to occur only between the odd-numbered X electrode X1 and the odd-numbered Y electrode Y1 and no sustain discharge is caused to occur between the even-numbered X electrode X2 and the even-numbered Y electrode Y2, therefore, the numbers of sustain discharges are made equal to each other by controlling such that the sustain discharge is caused to occur only between the even-numbered X electrode X2 and the even-numbered Y electrode Y2 and that no sustain discharge is caused to occur between the odd-numbered X electrode X1 and the odd-numbered Y electrode Y1 at the end of the sustain discharge period.

The drive waveforms in the odd-numbered field are explained as above. As for the drive waveforms in the even-numbered field, the same drive waveform as that in the odd-numbered field is applied to the odd-numbered Y electrode Y1 and the even-numbered Y electrode Y2, the drive waveform applied to the even-numbered X electrode X2 in the odd-numbered field is applied to the odd-numbered X electrode X1, the drive waveform applied to the odd-numbered X electrode X1 in the odd-numbered field is applied to the even-numbered X electrode X2, the drive waveform applied to the Z electrode Z2 in the second group in the odd-numbered field is applied to the Z electrode Z1 in the first group, the drive waveform applied to the Z electrode Z1 in the first group in the odd-numbered field is applied to the Z electrode Z2 in the second group, the drive waveform applied to the Z electrode Z4 in the fourth group in the odd-numbered field is applied to the Z electrode Z3 in the third group, and the drive waveform applied to the Z electrode Z3 in the third group in the odd-numbered field is applied to the Z electrode Z4 in the fourth group.

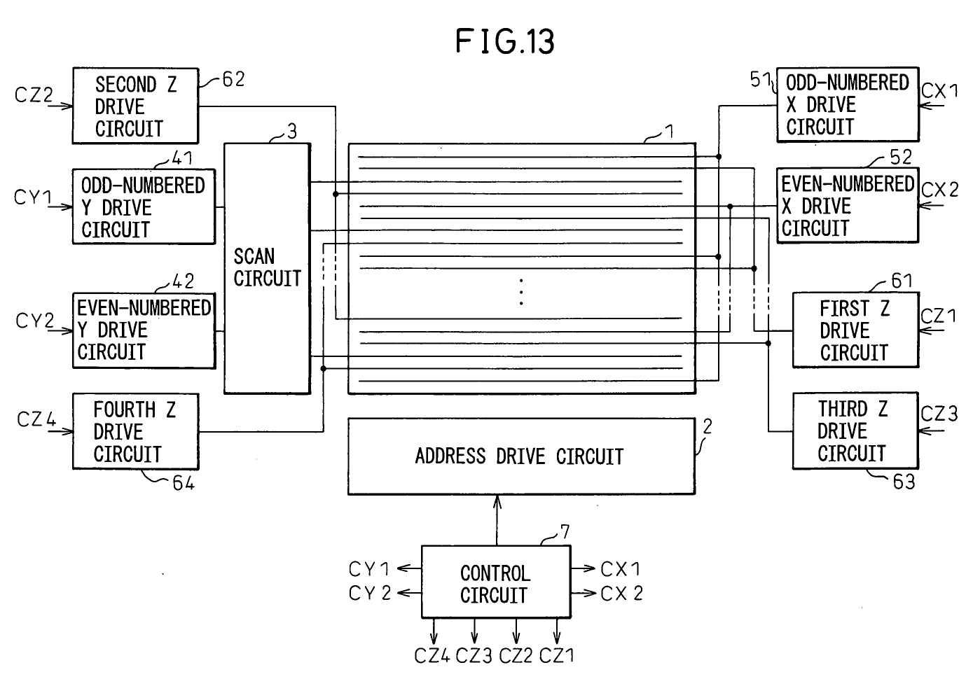

FIG. 13 is a diagram showing a general configuration of the PDP device in a modification example of the second embodiment. The modification example differs from the second embodiment in that the Z electrode Z1 in the first group and the Z electrode Z3 in the third group are extended to the right side of the panel 1 and the Z electrode Z2 in the second group and the Z electrode Z4 in the fourth group are extended to the left side of the panel 1, that is, the Z electrodes are extended to the right and left sides alternately.

The PDP device in the second embodiment is explained as above and it is also possible to apply the modification example explained in the first embodiment to the ALIS system PDP device in the second embodiment.

As described above, according to the present invention, it is possible to provide a plasma display panel capable of improving the light emission luminance of a PDP and of realizing a PDP device of high display quality at low cost.

We claim:

1. A method for driving a plasma display panel comprising:
a plurality of first and second electrodes alternately provided in parallel to each other and between adjacent electrodes of which a repetitive discharge is caused to occur; and
a plurality of third electrodes each provided between the first and second electrodes between which the repetitive discharge is caused to occur and covered with a dielectric layer,
wherein at least during the discharge period during which the repetitive discharge is caused to occur between the first and second electrodes, the third electrode is set to substantially the same potential of the electrode used as a cathode during the discharge between the first and second electrodes.

2. The method for driving a plasma display panel as set forth in claim 1, wherein the discharge period during which the third electrode is set to substantially the same potential of the electrode used as a cathode during the repetitive discharge includes at least a period during which a discharge is started, then the discharge intensity reaches its peak and the falling period starts, and the intensity of the infrared light generated by the discharge falls from the peak to a little more than 10% thereof.

3. The method for driving a plasma display panel as set forth in claim 1, wherein the third electrode is set to substantially the same potential of the electrode used as an anode during the repetitive discharge between the first and second electrodes except for the period during which the third electrode is set to substantially the same potential of the electrode used as a cathode.

4. The method for driving a plasma display panel as set forth in claim 3, wherein after the third electrode is set to substantially the same potential of the electrode used as an anode during the repetitive discharge between the first and second electrodes and when one of the first and second electrodes is turned from an anode to a cathode, the third electrode is set to substantially the same potential as the electrode used as a cathode during the repetitive discharge between the first and second electrodes.

5. The method for driving a plasma display panel as set forth in claim 2, wherein the period during which the third electrode is set to substantially the same potential as the electrode used as a cathode during the repetitive discharge between the first and second electrodes is long at the beginning of the repetitive discharge and shorter afterward.

6. The method for driving a plasma display panel as set forth in claim 1, wherein the plurality of first and second electrodes make up pairs, the third electrode is provided between a pair of the first electrode and the second electrode, and a common potential is applied to the plurality of third electrodes.

7. The method for driving a plasma display panel as set forth in claim 1, wherein:
the plurality of third electrodes are each provided at every portion between the plurality of first electrodes and the plurality of second electrodes;
an odd-numbered field in which the repetitive discharge is caused to occur between the second electrode and the first electrode adjacent to one side thereof, and an even-numbered field in which the repetitive discharge is caused to occur between the second electrode and the first electrode adjacent to the other side thereof are provided;
at least during the discharge period during which the repetitive discharge is caused to occur in the odd-numbered field, the third electrode provided between the second electrode and the first electrode adjacent to one side thereof is set to substantially the same potential as the electrode used as a cathode during the repetitive discharge between the first and second electrodes, and the third electrode provided between the second electrode and the first electrode adjacent to the other side thereof is set to a potential that prevents a discharge from occurring and propagating; and
at least during the discharge period during which the repetitive discharge is caused to occur in the even-numbered field, the third electrode provided between the second electrode and the first electrode adjacent to one side thereof is set to a potential that prevents a discharge from occurring and propagating, and the third electrode provided between the second electrode and the first electrode adjacent to the other side thereof is set to substantially the same potential of the electrode used as a cathode during the repetitive discharge between the first and second electrodes.

8. The method for driving a plasma display panel as set forth in claim 1, wherein the plurality of third electrodes are alternately extended to the right and left sides of the plasma display panel.

9. A plasma display device comprising:
a plurality of first and second electrodes alternately provided in parallel to each other and between neighboring electrodes of which a repetitive discharge is caused to occur; and
a plurality of third electrodes each provided between the first and second electrodes between which the repetitive discharge is caused to occur and covered with a dielectric layer, further comprising:
a first electrode drive circuit for driving the plurality of first electrodes;
a second electrode drive circuit for driving the plurality of second electrodes; and
a third electrode drive circuit for driving the plurality of third electrodes, wherein
the third electrode drive circuit sets the third electrode to substantially the same potential as the electrode used as a cathode during the discharge between the first and second electrodes at least during the discharge period during which the repetitive discharge is caused to occur between the first and second electrodes.

10. The plasma display device as set forth in claim 9, wherein the third electrode drive circuit sets the third electrode to substantially the same potential as the electrode used as an anode during the repetitive discharge between the first and second electrodes except for the period during which the third electrode is set to substantially the same potential as the electrode used as a cathode.

11. The plasma display device as set forth in claim 9, wherein after the third electrode drive circuit sets the third electrode to substantially the same potential as the electrode used as an anode during the repetitive discharge between the first and second electrodes and when one of the first and second electrodes is turned from an anode to a cathode, the third electrode drive circuit sets the third electrode to substantially the same potential of the electrode used as a cathode during the repetitive discharge between the first and second electrodes.

12. The plasma display device as set forth in claim 9, wherein the third electrode drive circuit sets long the period during which the third electrode is set to substantially the same potential of the electrode used as a cathode during the repetitive discharge between the first and second electrodes at the beginning of the repetitive discharge and shorter afterward.

13. The plasma display device as set forth in claim 9, wherein:
the plurality of first and second electrodes make up pairs and the third electrode is provided between a pair of the first electrode and the second electrode; and
the third electrode drive circuit applies a common potential to the plurality of third electrodes.

14. The plasma display device as set forth in claim 9, wherein:
the plurality of third electrodes are each provided at every portion between the plurality of first electrodes and the plurality of second electrodes;
an odd-numbered field in which the repetitive discharge is caused to occur between the second electrode and the first electrode adjacent to one side thereof, and an even-numbered field in which the repetitive discharge is caused to occur between the second electrode and the first electrode adjacent to the other side thereof are provided;
the third electrode drive circuit sets, at least during the discharge period during which the repetitive discharge is caused to occur in the odd-numbered field, the third electrode provided between the second electrode and the first electrode adjacent to one side thereof to substantially the same potential as the electrode used as a cathode during the repetitive discharge between the first and second electrodes, and sets the third electrode provided between the second electrode and the first electrode adjacent to the other side thereof to a potential that prevents a discharge from occurring and propagating; and
the third electrode drive circuit sets, at least during the discharge period during which the repetitive discharge is caused to occur in the even-numbered field, the third electrode provided between the second electrode and the first electrode adjacent to one side thereof to a potential that prevents a discharge from occurring and propagating, and sets the third electrode provided between the second electrode and the first electrode adjacent to the other side thereof to substantially the same potential of the electrode used as a cathode during the repetitive discharge between the first and second electrodes.

15. The plasma display device as set forth in claim 14, wherein the plurality of third electrodes are alternately extended to the right and to the left and are connected to the third electrode drive circuit.
